(19) United States
(12) Patent Application Publication
(10) Pub. No.: US 2025/0358515 A1
(43) Pub. Date: Nov. 20, 2025

(54) IMAGING APPARATUS

(71) Applicant: Panasonic Intellectual Property Management Co., Ltd., Osaka (JP)

(72) Inventors: Yuki MIURA, Osaka (JP); Naoto SUEHIRO, Osaka (JP); Kiyokazu SASAKI, Nara (JP)

(73) Assignee: Panasonic Intellectual Property Management Co., Ltd., Osaka (JP)

(21) Appl. No.: 19/205,045

(22) Filed: May 12, 2025

(30) Foreign Application Priority Data
May 14, 2024 (JP) 2024-078918

(51) Int. Cl. H04N 23/67; H04N 23/611; H04N 23/63

(52) U.S. Cl. CPC H04N 23/675; H04N 23/611; H04N 23/632

(57) ABSTRACT

An imaging apparatus includes: an image sensor that captures a subject image formed via an optical system to generate image data; and a controller that controls focusing operation by the optical system. Before a subject is detected in a first focusing area, the controller causes the optical system to perform the focusing operation, based on the first focusing area, the first focusing area being arranged in advance in a captured image indicated by the image data. After the subject is detected in the first focusing area, the controller causes the optical system to perform the focusing operation with tracking the subject over a range away from the first focusing area.

### TECHNICAL FIELD

The present disclosure relates to an imaging apparatus that performs focusing operation.

### BACKGROUND ART

JP 2006-72332 A discloses an imaging apparatus capable of performing focus adjustment on an optionally settable subject. The imaging apparatus includes an imaging optical system and a color information calculation unit that calculates color information for each of a plurality of areas from an image signal. The imaging apparatus selects at least one area based on a result of comparison between preset reference color information and each piece of color information sequentially calculated by the color information calculation unit, and calculates focusing information of an imaging optical system for the selected area. The reference color information is color information calculated by the color information calculation unit for an area desired by the user from an image signal captured in advance.

### SUMMARY

The present disclosure provides an imaging apparatus capable of facilitating realization of focusing operation of tracking a subject from a desired area.

An imaging apparatus according to the present disclosure includes: an image sensor that captures a subject image formed via an optical system to generate image data; and a controller that controls focusing operation by the optical system. Before a subject is detected in a first focusing area, the controller causes the optical system to perform the focusing operation, based on the first focusing area, the first focusing area being arranged in advance in a captured image indicated by the image data. After the subject is detected in the first focusing area, the controller causes the optical system to perform the focusing operation with tracking the subject over a range away from the first focusing area. According to the imaging apparatus of the present disclosure, it is possible to facilitate realization of focusing operation of tracking a subject from a desired area.

### BRIEF DESCRIPTION OF DRAWINGS

FIG. 1 is a diagram illustrating a configuration of a digital camera according to a first embodiment of the present disclosure;

FIG. 2 is a diagram illustrating a display example of a setting menu of an AF mode in a digital camera;

FIGS. 3A to 3C are diagrams for explaining operation in a standby tracking mode in the digital camera;

FIG. 4 is a flowchart illustrating operation in the standby tracking mode in the digital camera according to the first embodiment;

FIGS. 5A and 5B are diagrams for explaining processing of detecting a target subject in the digital camera;

FIG. 6 is a diagram for explaining AF tracking at the time of loss of a target subject in image recognition in the digital camera;

FIG. 7 is a diagram illustrating a display example of a setting screen of a standby AF area in the digital camera;

FIG. 8 is a diagram illustrating a display example of a setting screen for a target subject in the digital camera;

FIG. 9 is a flowchart illustrating operation in the standby tracking mode in the digital camera according to a second embodiment;

FIGS. 10A and 10B are diagrams for explaining an operation example of the standby tracking mode in the digital camera of the second embodiment; and

FIGS. 11A to 11C are diagrams for explaining a variation of setting of a target subject in the digital camera.

### DETAILED DESCRIPTION

Hereinafter, embodiments will be described in detail with reference to the drawings as appropriate. However, an unnecessarily detailed description will be omitted in some cases. For example, detailed descriptions of already well-known matters and repetition of descriptions of substantially the same configuration will be omitted in some cases. This is to prevent the following description from being unnecessarily redundant and to facilitate those skilled in the art to understand the present disclosure. Note that the inventor or inventors provide the accompanying drawings and the following description for those skilled in the art to fully understand the present disclosure and the drawings and the description are not intended to limit the subject matters of the claims.

### First Embodiment

In a first embodiment, a digital camera as an example of an imaging apparatus according to the present disclosure will be described.

### 1. Configuration

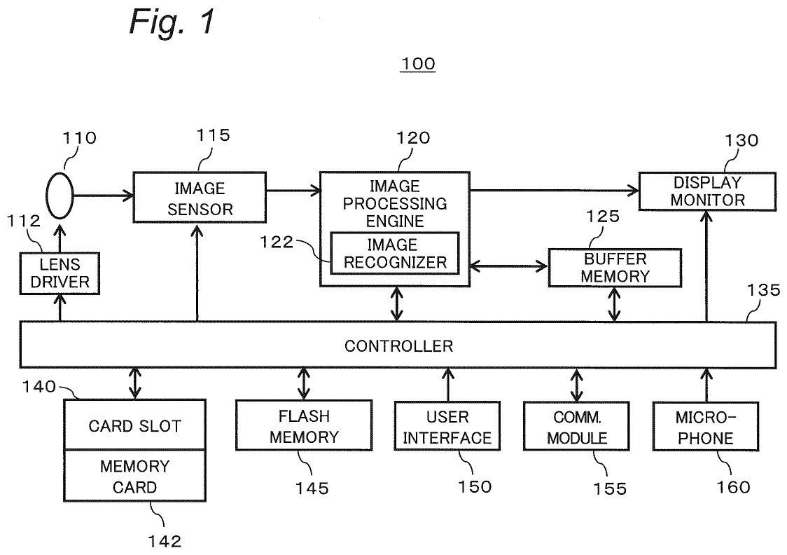

With reference to FIG. 1, a configuration of a digital camera according to the first embodiment will be described.

FIG. 1 is a diagram illustrating the configuration of a digital camera 100 according to the present embodiment. The digital camera 100 of the present embodiment includes an image sensor 115, an image processing engine 120, a display monitor 130, and a controller 135. Furthermore, the digital camera 100 includes a buffer memory 125, a card slot 140, a flash memory 145, a user interface 150, a communication module 155, and a microphone 160. The digital camera 100 further includes an optical system 110 and a lens driver 112, for example.

The optical system 110 includes a focusing lens, a zooming lens, an optical image stabilization (OIS) lens, an aperture diaphragm, a shutter, and the like. The focusing lens is a lens for changing a focusing state of a subject image formed on the image sensor 115. The zooming lens is a lens for changing a magnification ratio of a subject image formed by the optical system. The focusing lens and the other lenses are each configured with one or a plurality of lenses.

The lens driver 112 drives the focusing lens and the like in the optical system 110. The lens driver 112 includes a motor to move the focusing lens along an optical axis of the optical system 110 under the control of the controller 135. A configuration, in the lens driver 112, for driving the focusing lens can be realized by a DC motor, a stepping motor, a servo motor, an ultrasonic motor, or the like.

The image sensor 115 captures a subject image formed via the optical system 110 and generates imaging data. The imaging data is image data showing a captured image by the image sensor 115. For example, the image sensor 115 generates new frames of image data at a predetermined frame rate (e.g., 30 frames/second). The controller 135 controls a generation timing of the imaging data and an operation of an electronic shutter in the image sensor 115. As the image sensor 115, it is possible to use various image sensors such as a complementary metal-oxide semiconductor (CMOS) image sensor, a charge-coupled device (CCD) image sensor, or an n-channel metal oxide semiconductor (NMOS) image sensor.

The image sensor 115 performs an operation of capturing a still image, an operation of capturing a through image, and the like. The through image is mostly a moving image and is displayed on the display monitor 130 for a user to determine a composition for image capturing of a still image. The through image and the still image are each an example of a captured image in the present embodiment. The image sensor 115 is an example of an image sensor of the present embodiment.

The image processing engine 120 performs various processing on the imaging data outputted from the image sensor 115 to generate image data and performs various processing on the image data to generate an image to be displayed on the display monitor 130. Examples of the various processing include white balance correction, gamma correction, YC conversion processing, electronic zoom processing, compression processing, and decompression processing, but the processing is not limited to these examples. The image processing engine 120 may be configured with a hard-wired electronic circuit, and may be configured with a microcomputer, a processor, or the like using a program.

In the present embodiment, the image processing engine 120 includes an image recognizer 122 that realizes a function of identifying a subject and the like including a human, by image recognition of a captured image. Details of the image recognizer 122 will be described later.

The display monitor 130 is an example of a display to display various information. For example, the display monitor 130 displays an image (through image) shown by image data that is captured by the image sensor 115 and is subjected to image processing of the image processing engine 120. The display monitor 130 further displays a menu screen or the like for a user to set various settings of the digital camera 100. The display monitor 130 can be configured with a liquid crystal display device or an organic electroluminescence (EL) device, for example. The digital camera 100 may further include a connecter connected to an external display such as an HDMI (registered trademark) terminal.

The user interface 150 is a collective name for hardware keys such as an operation button and an operation lever provided on an outer casing of the digital camera 100 and is an example of an input interface that receives operation by the user. For example, the user interface 150 includes a shutter release button, a mode dial, and a touch panel. When receiving an operation by a user, the user interface 150 transmits to the controller 135 an operation signal corresponding to the user operation.

The controller 135 collectively controls operation of the whole of the digital camera 100. The controller 135 includes a central processing unit (CPU) and the like, and the CPU executes a program (software) to realize predetermined functions. Instead of the CPU, the controller 135 may include a processor configured with a dedicated electronic circuit designed to realize predetermined functions. That is, the controller 135 can be realized by various processors such as a CPU, a microprocessor unit (MPU), a graphic processor unit (GPU), a digital signal processor (DSP), a field programable gate array (FPGA), and an application specific integrated circuit (ASIC). The controller 135 may be configured with one or a plurality of processors. The controller 135 may be configured with one semiconductor chip together with the image processing engine 120 and the like.

The buffer memory 125 is a recording medium functioning as a working memory for the image processing engine 120 and the controller 135. The buffer memory 125 is realized by a dynamic random access memory (DRAM) or other component. The flash memory 145 is a nonvolatile recording medium. Further, not shown in the drawings, the controller 135 may include various internal memories and may incorporate a read-only memory (ROM), for example. The ROM stores various programs to be executed by the controller 135. The controller 135 may incorporate a random access memory (RAM) functioning as a working area for the CPU.

The card slot 140 is a module into which a detachable memory card 142 is inserted. To the card slot 140, the memory card 142 can be electrically and mechanically connected. The memory card 142 is an external memory including therein a recording element such as a flash memory. The memory card 142 can store data such as image data generated by the image processing engine 120.

The communication module 155 is a communication module (circuit) that performs communication in conformity with the communication standard IEEE 802.11, the Wi-Fi standard, or the like. The digital camera 100 can communicate with other devices via the communication module 155. The digital camera 100 may directly communicate with other devices via the communication module 155, or may communicate via an access point. The communication module 155 may be connectable to a communication network such as the Internet. The communication module 155 may function as a connecter connected to an external display.

The microphone 160 is an example of an input interface including one or more microphone elements built in the digital camera 100, for example. The microphone 160 outputs a sound signal indicating collected sound to the controller 135. An external microphone may be used in the digital camera 100. The digital camera 100 may include a connecter such as a terminal connected to an external microphone in place of or in addition to the built-in microphone 160.

### 1-1. Image Recognizer

Details of the image recognizer 122 in the present embodiment will be described below.

The image recognizer 122 adopts a trained model by a neural network such as a convolutional neural network. The image recognizer 122 acquires information showing a captured image by the image sensor 115, and executes image recognition processing by the model. The image recognizer 122 may be configured by cooperation of the image processing engine 120 and the controller 135.

For example, the processing of a trained model in the image recognizer 122, outputs an area (i.e., a subject area), in which a subject classified into any of a plurality of preset types is shown in an input image, as output information in association with each type. For example, the plurality of types shows classification of categories of various subjects such as a human, an animal, and a vehicle. The subject area is defined by horizontal coordinates and vertical coordinates on an image to be processed in a manner that a recognized subject is surrounded in a rectangular shape, for example.

As types in the image recognizer 122, various types can be adopted. For example, the above category of animal may be further classified depending on a type of animal, and for example, types such as a dog, a cat, and a bird may be separately set. The category of vehicle may be classified into a railway, a motorcycle, an automobile, and the like. The category of human may be classified by an individual, gender, age, nationality, and the like. The image recognizer 122 may perform image recognition to identify an image-shooting scene of an input image by category classes of a plurality of previously set image-shooting scenes, for example.

The trained model of the image recognizer 122 as described above can be obtained by supervised learning using, as teacher data, image data associated with a ground truth label indicating that an image showing a subject of each type is a ground truth, for example. The trained model may generate reliability or likelihood regarding a recognition result of each type. The subject area recognized by the image recognizer 122 is not particularly limited to a rectangular shape, and may have various shapes. For example, the image recognizer 122 may recognize an area along an outer shape of a subject as the subject area by using a segmentation technique for image recognition.

The trained model of the image recognizer 122 is not necessarily of the neural network, and may be a machine learning model related to various image recognition. The image recognizer 122 may adopt not only machine learning but also various image recognition algorithms. The image recognizer 122 may be configured such that recognition with respect to some types such as a face and a pupil of a human is performed by rule-based image recognition processing. The image recognizer 122 may be configured with a DSP or the like, for example. The image recognizer 122 may be configured separately from the image processing engine 120, or may be configured integrally with the controller 135.

### 1-2. AF Mode

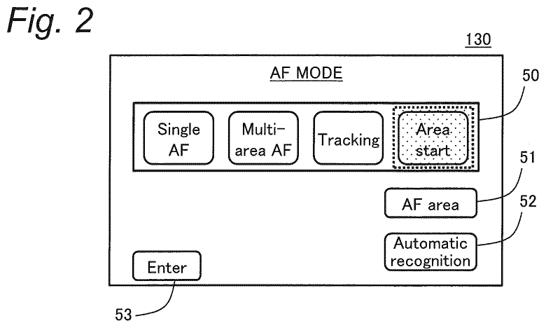

The digital camera 100 according to the present embodiment has a plurality of AF modes having different characteristics for performing AF operation, and includes a setting menu for setting various AF modes by user operation, for example. A configuration example of the setting menu of an AF mode in the digital camera 100 will be described with reference to FIG. 2.

In the example of FIG. 2, the display monitor 130 of the digital camera 100 displays, in a setting menu of an AF mode, a selection field 50 for an AF mode, an AF area setting button 51, an automatic recognition setting button 52, and a determination button 53 for determining setting of an AF mode.

The controller 135 of the digital camera 100 receives user operation on the display screen of the setting menu on the user interface 150 such as a touch panel or an operation button. For example, the user can input touch operation of each portion on various display screens or operation of a corresponding physical operation button or the like to the digital camera 100. The user interface 150 is an example of a setting interface in the digital camera 100.

The selection field 50 for an AF mode receives user operation of selecting an AF mode to be set in the digital camera 100 by touch operation or the like from various AF mode options such as “single-point AF”, “multi-area AF”, “tracking”, and “area start”. Various AF modes in the selection field 50 are examples of a plurality of operation modes in the digital camera 100.

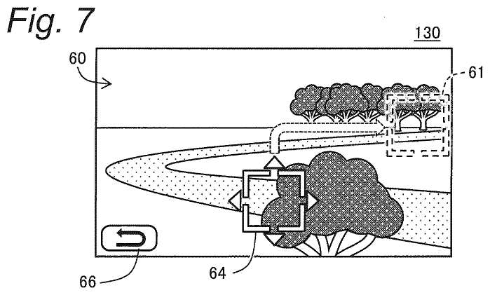

For example, the AF area setting button 51 receives user operation of setting, on a through image, arrangement of various areas (e.g., AF areas) used for an AF mode being selected in the selection field 50 for an AF mode (see FIG. 7). For example, an AF area is an area to be focused in AF operation of the digital camera 100, and is visualized to the user by frame display on a through image or the like. The AF area setting button 51 may be omitted depending on an option of an AF mode, for example.

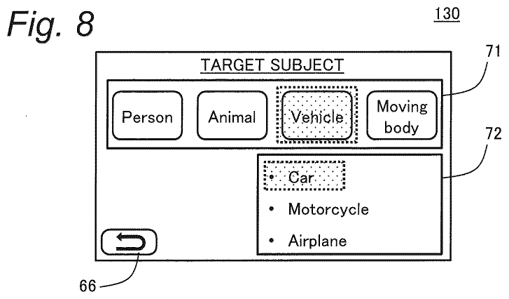

For example, the automatic recognition setting button 52 receives user operation for setting ON/OFF (valid/invalid) and the like of an automatic recognition function that is a function of automatically recognizing a specific subject by the image recognizer 122. The automatic recognition function may be settable by user operation in each AF mode, or may be settable by the user in a specific AF mode. When the automatic recognition setting button 52 is ON, the digital camera 100 receives user operation for detailed setting selecting a type of a subject (hereinafter referred to as “target subject”) to be a target of the automatic recognition function (see FIG. 8), for example.

In the selection field 50 for an AF mode, “single-point AF” is an option of an AF mode in which AF operation is performed so as to perform focusing within one AF area set in advance by the AF area setting button 51, for example. In a case where the automatic recognition function is ON in this present AF mode, when the target subject is detected in a preset AF area, a result of the detection is used for AF operation. For example, when the target subject moves away from a preset AF area, this AF mode returns to AF operation based on the AF area.

The “multi-area AF” is an option of an AF mode in which AF operation is performed while AF areas are switched from a plurality of areas arranged in advance over an entire area of a through image 60, for example. In this present AF mode, when the automatic recognition is ON, a specific subject is detected in the entire area of a through image, to change an AF area according to a result of the detection, for example. Arrangement of a plurality of areas is not particularly limited to the entire area of a through image, and may be partial.

The “tracking” is an option of an AF mode in which AF operation is performed while moving an AF area so as to track a subject. This AF mode is executed so as to track a subject in a predetermined area on a through image at the start of AF operation, for example. Various arrangements of the predetermined area can be set from the AF area setting button 51, for example. For example, in a case where the automatic recognition function is ON, when the target subject is inside the predetermined area at the start of AF operation, the AF operation is performed so as to track the subject. Then, even if the subject moves out of the predetermined area, detection of the subject and the AF operation are continued. On the other hand, when no target subject is in the predetermined area, a tracking target is determined by automatic determination of the digital camera 100. Then, the focus may be shifted to the outside of the predetermined area. For example, when the target subject is not inside but outside the predetermined area at the start of AF operation, the AF operation may be performed so as to track the subject from the outside of the predetermined area.

The “area start” is an option indicating a new operation mode provided in the digital camera 100 of the present embodiment as an AF mode. The digital camera 100 according to the present embodiment provides a new operation mode (hereinafter, referred to as “standby tracking mode”) in which a user's desired subject is set to standby in an AF area arranged in advance, and AF operation is performed so as to start tracking of the subject from the AF area. According to the standby tracking mode of the present embodiment, it is possible to more easily perform AF operation suitable for a shooting scene such as tracking a subject from an AF area desired by the user than in each of the above-described AF modes (details will be described later).

In the present embodiment, as an AF mode of the digital camera 100, an available AF mode may be switched according to setting such as still image shooting or moving image shooting, or continuous AF (AFC) or single AF (AFS). For example, the standby tracking mode of the present embodiment may be available in setting of AFC in still image shooting or in moving image shooting.

### 2. Operation

A description will be given below to the operation of the digital camera 100 configured as described above.

The digital camera 100 captures, with the image sensor 115, a subject image formed via the optical system 110 and generates imaging data. The image processing engine 120 performs various processing on the imaging data generated by the image sensor 115 to generate image data. For example, in the operation of capturing a still image or a moving image, the controller 135 records image data generated by the image processing engine 120 in the memory card 142 attached to the card slot 140.

The digital camera 100 displays a through image on the display monitor 130 in the operation of capturing a through image. The user can check the composition for shooting an image, by the through image on the display monitor 130. For example, in response to an operation of the shutter release button by the user, the controller 135 controls the AF operation in which the focusing lens of the optical system 110 is driven by the lens driver 112 so as to automatically focus on a subject.

### 2-1. Outline of Operation

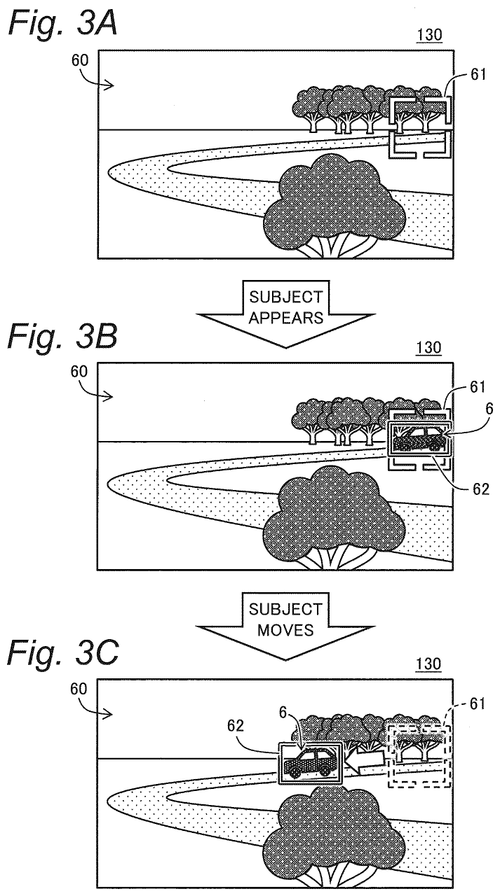

An outline of operation in the standby tracking mode in the digital camera 100 of the present embodiment will be described with reference to FIGS. 3A to 3C.

FIGS. 3A to 3C illustrate a series of operation examples in which the standby tracking mode of the present embodiment is applied to a shooting scene in which a target subject 6 desired by the user moves from the outside of an angle of view range of the digital camera 100. FIG. 3A illustrates a display example of a through image 60 before appearance of the target subject 6 in the digital camera 100 of the present embodiment. FIG. 3B illustrates a display example of the through image 60 when the target subject 6 appears after FIG. 3A. FIG. 3C illustrates a display example of the through image 60 when the target subject 6 moves, subsequent to FIG. 3B.

For example, at the initial stage of operating in the standby tracking mode, the digital camera 100 of the present embodiment arranges an AF area 61 at a preset initial position on the through image 60 of the display monitor 130 as illustrated in FIG. 3A. The AF area 61 in an initial state of the standby tracking mode will be hereinafter referred to as “standby AF area 61”. The user can set the standby AF area 61 at a position where the desired target subject 6 is expected to appear on the through image 60 of the digital camera 100, for example.

In the initial state, the digital camera 100 of the present embodiment performs AF operation in parallel with processing of detecting the target subject 6 by image recognition, based on the standby AF area 61 arranged on the through image 60, for example. For example, in the example of FIG. 3A, the target subject 6 has not appear in the through image 60 yet, and the digital camera 100 continues to focus on the background in the standby AF area 61.

In FIG. 3B, the target subject 6 enters the standby AF area 61 after FIG. 3A. Then, the digital camera 100 detects the target subject 6, and displays a recognition result of the target subject 6 by image recognition as an AF area 62 on the display monitor 130 (hereinafter, referred to as “recognized AF area 62”). At this time, the digital camera 100 performs AF operation based on the recognized AF area 62 of the target subject 6. In this manner, the digital camera 100 of the present embodiment can quickly change the focus on the target subject 6 from the background in the standby AF area 61.

After detecting the target subject 6 once in the standby AF area 61, the digital camera 100 according to the present embodiment performs AF operation so as to track the target subject 6 in the entire through image 60, for example. In the example of FIG. 3C, the target subject 6 moves after FIG. 3B and is out of the standby AF area 61. Even in such a case, the digital camera 100 of the present embodiment can keep focusing on the target subject 6 by performing AF operation based on the recognized AF area 62 of the target subject 6, for example.

As described above, according to the standby tracking mode of the digital camera 100 in the present embodiment, the user can obtain AF operation of waiting for the appearance of the target subject 6, and tracking movement of the target subject 6 from the standby AF area 61 where the appearance is expected, for example.

### 2-2. Details of Operation

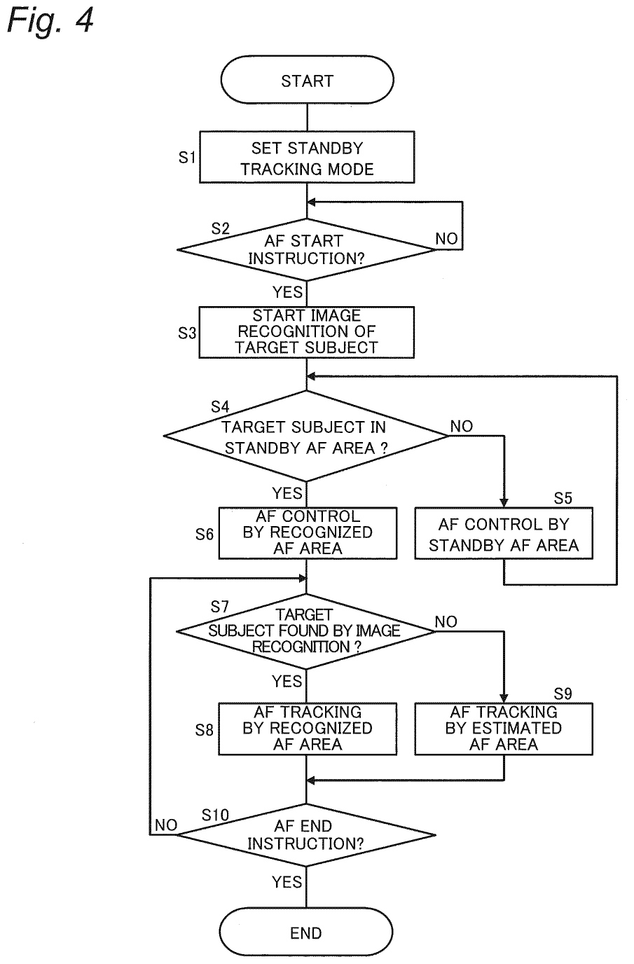

Details of operation in the standby tracking mode in the digital camera 100 according to the present embodiment as described above will be described with reference to FIGS. 4 to 6.

FIG. 4 is a flowchart illustrating operation in the standby tracking mode in the digital camera 100 according to the first embodiment. The flow of FIG. 4 is started in a state where the digital camera 100 is set to the standby tracking mode in the setting menu of FIG. 2, for example. This flow is executed by the controller 135 in parallel with imaging operation of the through image 60 for each frame in the digital camera 100, for example.

First, the controller 135 of the digital camera 100 acquires setting information for executing the standby tracking mode (S1). For example, the setting information includes information related to arrangement such as a position and size of the standby AF area 61, and information (e.g., a type) indicating the target subject 6 to be tracked.

In step S1, the controller 135 may acquire the setting information according to user setting, or may acquire setting information set in advance by the user from the flash memory 145 or the like. Details of user setting of the standby tracking mode will be described later.

Next, the controller 135 receives an instruction to start AF operation according to user operation on the user interface 150, for example (S2). For example, the AF start instruction subject to step S2 is half-press operation of a release button in a case of still image shooting, and is operation of a moving image button for starting shooting in a case of moving image shooting.

When the AF start instruction is input (YES in S2) the controller 135 first causes the image recognizer 122 to start image recognition of the target subject 6, for example (S3). For example, the image recognizer 122 executes image recognition processing for each frame of the through image 60 sequentially captured by the image sensor 115, and outputs output information of a recognition result to the controller 135. The start of image recognition (S3) may be executed before proceeding to YES in step S2 without particularly limiting to a time point of starting AF operation, for example.

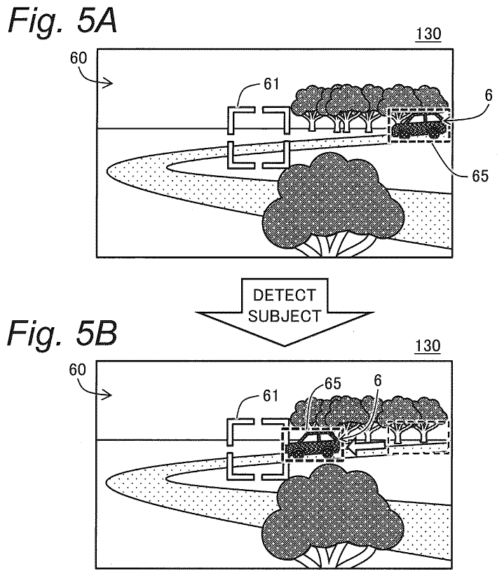

Next, the controller 135 performs processing of detecting whether or not the target subject 6 is present in the standby AF area 61 in the current through image 60 based on the output information of the image recognizer 122, for example (S4). Detection processing in step S4 will be described with reference to FIGS. 5A and 5B.

FIG. 5A illustrates the through image 60 in a case where the target subject 6 is not detected (NO in S4). FIG. 5B illustrates the through image 60 in a case where the target subject 6 is detected (YES in S4). Note that FIGS. 5A and 5B illustrate an example in which the arrangement of the standby AF area 61 is different from that in the examples of FIGS. 3A and 3B for convenience of description.

FIGS. 5A and 5B illustrate a subject area 65 showing a recognition result of the target subject 6 by the image recognizer 122. In step S4, the controller 135 compares a position of the subject area 65 indicated by the output information of the image recognizer 122 with a position of the standby AF area 61, so as to perform detection processing of the target subject 6 in the standby AF area 61, for example.

For example, as illustrated in FIG. 5A, when no overlap between the subject area 65 and the standby AF area 61 is present, the controller 135 does not detect the target subject 6 in the standby AF area 61 (NO in S4). At this time, the subject area 65 is not particularly displayed on the display monitor 130, for example. Also when output information of the image recognizer 122 does not include the subject area 65 and the target subject 6 is not recognized, the controller 135 proceeds to NO in step S4 (see FIG. 3A).

On the other hand, as illustrated in FIG. 5B, when the overlap between the subject area 65 and the standby AF area 61 is present, the controller 135 detects the target subject 6 in the standby AF area 61 (YES in S4). At this time, the subject area 65 is adopted to the recognized AF area 62 (FIG. 3B), to be displayed on the display monitor 130, for example. The subject area 65 and the recognized AF area 62 do not have to strictly coincide with each other, and may have an allowable error as appropriate.

Referring back to FIG. 4, in a case where the target subject 6 is not detected in the standby AF area 61 (NO in S4), the controller 135 performs various controls for executing AF operation based on the standby AF area 61 as illustrated in FIG. 3A, for example (S5).

In step S5, the controller 135 calculates an AF evaluation value such as a contrast value by detecting the standby AF area 61 (or an area in the vicinity of the standby AF area 61), for example. Next, the controller 135 controls the lens driver 112 to determine a focus lens position in the optical system 110 based on the calculated AF evaluation value. In the present embodiment, AF operation of the digital camera 100 is not limited to such a contrast system, and additionally or alternatively, an image plane phase difference system or DFD may be used, for example.

After step S5, the controller 135 performs the detection processing (S4) of the target subject 6 in the standby AF area 61 again based on output information of the image recognizer 122 for the through image 60 of a new frame. The detection processing in step S4 is repeatedly executed in a cycle such as a period of a predetermined number, one or more, of frames, for example. In steps S4 and S5, the controller 135 continues to display the standby AF area 61 arranged in the initial stage, for example.

In a case where the target subject 6 is detected in the standby AF area 61 (YES in S4), the controller 135 performs various controls for executing AF operation based on the recognized AF area 62 of the target subject 6 as illustrated in FIG. 3B, for example (S6). At this time, the controller 135 causes the display monitor 130 to display the subject area 65 (FIG. 5B) as the recognized AF area 62, for example.

The AF operation in step S6 is performed similarly to step S5 by using the recognized AF area 62 instead of the standby AF area 61, for example. In step S6, the controller 135 may extract information on a feature amount such as color information of the target subject 6. In the AF operation in steps S5 and S6, various parameter settings for executing the AF operation for an area other than the AF areas 61 and 62 may be common settings or different settings.

After the start of the AF control (S6) on the detected target subject 6, the controller 135 determines whether or not the target subject 6 is recognized by the image recognizer 122 in a new frame based on output information of an image recognition result of the through image 60 of the frame sequentially, for example (S7). For example, the controller 135 performs the determination in step S7 according to whether or not the subject area 65 of the target subject 6 is included in output information from the image recognizer 122.

When the target subject 6 is recognized by the image recognizer 122 (YES in S7), the controller 135 updates the recognized AF area 62 to the newly recognized subject area 65, and performs AF control similarly to step S6 (S8). Then, as illustrated in FIG. 3C, the digital camera 100 of the present embodiment can perform AF operation by moving the recognized AF area 62 to track the target subject 6 even if the target subject 6 is out of the standby AF area 61 (S8), for example.

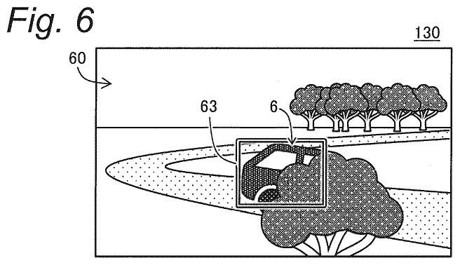

On the other hand, when the target subject 6 is not recognized by the image recognizer 122 (NO in S7), the digital camera 100 of the present embodiment controls AF operation to track the target subject 6 based on a different means from the image recognition resulting in the loss of the target subject 6 (S9). The processing in step S9 will be described with reference to FIG. 6.

FIG. 6 illustrates the through image 60 showing the target subject 6 only partially shown due to an obstacle and resulting in the loss of the target subject 6 in image recognition (NO in S7). In step S9, the controller 135 first determines the AF area 63 estimated as a result of tracking the target subject 6, as exemplified in FIG. 6, based on a feature amount such as color information or a motion vector of a portion of the target subject 6 in the through image 60 before and after the loss, for example. The AF area 63 is hereinafter referred to as “estimated AF area 63”.

For example, in step S9, the controller 135 compares color information extracted at the time of detection of the target subject 6 (YES in S4) with color information in the current through image 60, so as to be able to determine an area having the color information of the target subject 6 as the estimated AF area 63. Alternatively, the controller 135 may determine an area predicted to correspond to the target subject 6 in the current through image 60 as the estimated AF area 63 with reference to a motion vector of the subject area 65 in the through image 60 immediately before the loss.

For example, as illustrated in FIG. 6, the controller 135 causes the display monitor 130 to display the estimated AF area 63, and performs AF control based on the estimated AF area 63 (S9). The AF operation in step S9 is performed similarly to step S8 using the estimated AF area 63 instead of the recognized AF area 62, for example. In this manner, even when the image recognizer 122 cannot recognize the target subject 6 (NO in S7), the digital camera 100 of the present embodiment can perform AF operation by tracking the target subject 6 in the estimated AF area 63 (S9).

For example, after the AF operation tracking in the recognized AF area 62 or the estimation AF area 63 (S8, S9), the controller 135 receives an instruction to end the AF operation in response to user operation on the user interface 150 (S10). For example, the AF end instruction subject to step S10 is release operation of half-press of a release button in a case of still image shooting, and is operation of a moving image button for ending shooting in a case of moving image shooting. The releasing operation of half-press may be completion of full-press operation of a release button. In this case, the digital camera 100 releases AF operation after shooting of a still image.

In a case where an AF end instruction is not input (NO in S10), the controller 135 performs the processing in and after step S7 again. In this manner, the digital camera 100 according to the present embodiment can cause the recognized AF area 62 or the estimated AF area 63 to track the target subject 6 until the end of AF operation is instructed (S7 to S9). Note that, in a case where the processing of step S9 is performed a predetermined number of times, the processing illustrated in this flow may be automatically ended. The predetermined number of times is e.g. a plurality of times, and may be once.

On the other hand, in a case where the AF end instruction is input (YES in S10), the controller 135 ends the processing illustrated in FIG. 4. Note that even in a case where the AF end instruction is input during repetition of the processing of steps S4 to S5, the digital camera 100 can end the processing of this flow.

According to the processing in the standby tracking mode described above, the digital camera 100 of the present embodiment first performs AF control and the detection processing of the target subject 6 in the standby AF area 61 (S4 to S5). In this manner, as illustrated in FIG. 3A, the digital camera 100 of the present embodiment can stand by for the target subject 6 by keeping focusing on the background or the like of the standby AF area 61 until the target subject 6 is detected.

After the above, when the target subject 6 is detected in the standby AF area 61 (YES in S4), as illustrated in FIGS. 3B and 3C, the controller 135 tracks the target subject 6 with the recognized AF area 62 by the image recognizer 122, for example (S5 to S8). In this manner, the digital camera 100 according to the present embodiment can easily realize AF operation for tracking the target subject 6 from the standby AF area 61.

Furthermore, even in a case where loss of the target subject 6 occurs in image recognition (NO in S7), the digital camera 100 of the present embodiment can complement tracking of the target subject 6 as illustrated in FIG. 6 by using the estimated AF area 63 based on a feature amount such as color information or a motion vector instead of the recognized AF area 62.

In the above description, an example of the detection processing (S4) of the target subject 6 is described. However, in the digital camera 100 of the present embodiment, the detection processing in step S4 is not particularly limited to the above example. For example, in a case where size of overlap between the subject area 65 and the standby AF area 61 is within a predetermined error range, the controller 135 may proceed to NO in step S4.

For example, the detection processing in step S4 may be performed based on an inclusion in which the standby AF area 61 includes the subject area 65, or various positional relations such as a distance between center positions of the areas, without particularly limiting to overlap between areas. In the present embodiment, the controller 135 can perform the detection processing (S4) of the target subject 6 according to whether or not the subject area 65 is in various predetermined ranges assumed to be in the vicinity of the standby AF area 61.

In the digital camera 100 of the present embodiment, the subject area 65 of an image recognition result may be displayed on the display monitor 130 regardless of a result of the detection processing (S4) in particular. The subject area 65 and the recognized AF area 62 may be displayed in a similar manner or may have different display modes.

### 2-2-1. Setting of Standby Tracking Mode

In the digital camera 100 of the present embodiment, the setting information (S1) of the standby tracking mode is set according to user operation from the setting menu (FIG. 2), for example. The setting of the standby tracking mode will be described with reference to FIGS. 7 and 8.

FIG. 7 illustrates a setting screen of the standby AF area 61 in the digital camera 100. For example, when the AF area setting button 51 is operated in a state where “area start” indicating the standby tracking mode is selected in the selection field 50 in the setting menu of an AF mode as in the example of FIG. 2, the controller 135 causes the display monitor 130 to make a transition to the setting screen of FIG. 7.

For example, the controller 135 superimposes a setting area 64 on the through image 60 on the setting screen of FIG. 7 to be displayed on the display monitor 130, and receives various user operations in the setting area 64 on the user interface 150. The setting area 64 is an area scheduled to be set as the standby AF area 61 in the standby tracking mode, for example. The user interface 150 is an example of a setting interface in the present embodiment.

For example, the controller 135 changes a position of the setting area 64 in response to touch operation such as dragging of the setting area 64 by the user or operation of up, down, left, and right direction keys. The controller 135 may change size of the setting area 64 by touch operation of pinch-in and -out or the like of the setting area 64. The user may arrange the setting area 64 at an assumed position of appearance of the target subject 6 on the through image 60, or, without limitation to this, the user can perform various arrangements for starting tracking of the target subject 6 on the through image 60.

In the standby AF area 61 setting screen (FIG. 7), the controller 135 sets final arrangement of the setting area 64 to arrangement of the standby AF area 61 in response to operation of a return button 66 to return the display monitor 130 to the setting menu in FIG. 2, for example. The arrangement of the standby AF area 61 as set in this manner is stored as setting information in the flash memory 145 of the digital camera 100, for example.

FIG. 8 illustrates a setting screen of the target subject 6 in the digital camera 100. For example, when the automatic recognition setting button 52 is operated to be in an ON state in a state of the setting menu illustrated in FIG. 2 as described above, the controller 135 causes the display monitor 130 to make a transition to the setting screen of FIG. 8.

The setting screen illustrated in FIG. 8 includes a selection field 71 for a category including categories such as “person”, “animal”, “vehicle”, and “moving body” as options, and a selection field 72 for a type of a subject included in a selected category. For example, the controller 135 receives user operation of selecting an option in each of the selection fields 71 and 72 on the user interface 150. The controller 135 sets a type of the target subject 6 according to operation of the return button 66 in a similar manner to the above, to store the type in the flash memory 145 or the like as setting information, for example.

In the example of FIG. 8, the type “car” included in the category “vehicle” is selected as a type of the target subject 6. In “animal”, classification of a type such as a dog, a cat, or a bird may be included. In “person”, classification of an adult, a child, a male, a female, or the like may be included. “Moving object” is an option for setting all moving subjects as the target subject 6 without classifying a subject desired by the user particularly into another category (or type). In the digital camera 100 according to the present embodiment, in a setting screen for the target subject 6, a type of the target subject 6 does not need to be particularly classified by category.

The digital camera 100 according to the present embodiment may receive user operation for changing a shape of the standby AF area 61, such as changing an aspect ratio of the setting area 64, on the setting screen (FIG. 7) of the standby AF area 61, for example. In the digital camera 100 of the present embodiment, arrangement of the standby AF area 61 is not necessarily limited to user operation, and may be automatically set. For example, the controller 135 of the digital camera 100 may automatically set the standby AF area 61 of the target subject 6 on the through image 60 based on setting of the target subject 6 and the through image 60, or may present the standby AF area 61 to the user.

### 3. Review

As described above, the digital camera 100 of the present embodiment includes the image sensor 115 which is an example of an image sensor, and the controller 135. The image sensor 115 captures a subject image formed via the optical system 110 and generates image data. The controller 135 controls focusing operation by the optical system 110 and the image sensor 115 that generates image data. Before the target subject 6 is detected in the standby AF area 61 as an example of a first focusing area arranged in advance in the through image 60 indicated by the image data (NO in S4), the controller 135 causes the optical system 110 to perform focusing operation based on the arranged standby AF area 61 (S5). After detecting the target subject 6 in the arranged standby AF area 61 (YES in S4), the controller 135 causes the optical system 110 to perform focusing operation in a manner of tracking the target subject 6 over a range away from the arranged standby AF area 61 (S6). By this, the digital camera 100 of the present embodiment can facilitate realization of focusing operation of tracking a subject from a desired area.

In the digital camera 100 of the present embodiment, the controller 135 may control the display monitor 130 that displays the through image 60 as an example of a captured image indicated by image data. The controller 135 causes the display monitor 130 to display the standby AF area 61 as an example of the first focusing area arranged in advance in the through image 60, and causes the optical system 110 to perform AF operation as an example of focusing operation based on the standby AF area 61 before the target subject 6 as an example of a subject is detected in the standby AF area 61 (NO in S4) (S5). After detecting the target subject 6 in the standby AF area 61 (YES in S4), the controller 135 causes the display monitor 130 to display the recognized AF area 62 as an example of a second focusing area that tracks the target subject 6 over a range away from the standby AF area 61 (S6).

According to the digital camera 100 described above, the standby AF area 61 and the recognized AF area 62 displayed on the through image 60 can facilitate realization of focusing operation of tracking a subject from a desired area such as the standby AF area 61, for example.

In the digital camera 100 according to the present embodiment, after detecting the target subject 6 in the standby AF area 61 (YES in S4), the controller 135 causes the optical system 110 to perform AF operation based on the recognized AF area 62 in a manner of tracking the target subject 6 over a range away from the standby AF area 61 (S6). By this, the digital camera 100 of the present embodiment can easily realize AF operation of tracking a subject from a desired area.

The digital camera 100 according to the present embodiment further includes the image recognizer 122 that recognizes the subject area 65 in which the target subject 6 is located in through image 60 based on image data. The controller 135 does not detect the target subject 6 when the subject area 65 is not within a predetermined range from the standby AF area 61 based on a recognition result of the image recognizer 122 (NO in S4). The controller 135 detects the target subject 6 when the subject area 65 is within a predetermined range from the standby AF area 61 (YES in S4). The digital camera 100 according to the present embodiment can detect the target subject 6 in the standby AF area 61 and facilitate realization of AF operation of tracking the target subject 6 from the standby AF area 61. The predetermined range is a range in which the subject area 65 overlaps the standby AF area 61, for example.

In the digital camera 100 according to the present embodiment, after detecting the target subject 6 (YES in S4), when the image recognizer 122 recognizes the subject area 65 (YES in S7), the controller 135 displays the recognized AF area 62 in a manner of tracking the target subject 6 based on the recognized subject area 65 (S8). After detecting the target subject 6 (YES in S4), when the image recognizer 122 does not recognize the subject area 65 (NO in S7), the controller 135 displays the estimated AF area 63 as an example of the second focusing area in a manner of tracking the target subject 6 based on a predetermined feature amount in the through image 60 (S9). In this manner, the digital camera 100 of the present embodiment can facilitate realization of AF operation of tracking the target subject 6 from the standby AF area 61 by image recognition, tracking the target subject 6 based on a feature amount also at the time of loss of the target subject 6 in image recognition, and tracking the target subject 6 from a desired area. The predetermined feature amount includes at least one of color information or a motion vector, for example.

The digital camera 100 of the present embodiment further includes the user interface 150 as an example of a setting interface that sets at least one of arrangement of the standby AF area 61 in the through image 60 and the target subject 6 to be detected according to operation of the user. By this, the digital camera 100 of the present embodiment can facilitate realization of focusing operation of tracking a specific subject from a specific area as desired by the user. In the present embodiment, the setting interface of the digital camera 100 may set any one of arrangement of the standby AF area 61 and the target subject 6 according to user operation.

In the digital camera 100 of the present embodiment, the controller 135 has a plurality of AF modes as a plurality of operation modes for controlling focusing operation (see FIG. 2), for example. When the standby tracking mode as an example of a specific operation mode among a plurality of operation modes is set, the controller 135 displays the standby AF area 61, and displays the recognized AF area 62 after the target subject 6 is detected in the standby AF area 61 (see FIG. 3). With the standby tracking mode, the digital camera 100 of the present embodiment can facilitate realization of AF operation of tracking a subject from a desired area.

The digital camera 100 according to the present embodiment further includes the display monitor 130 that displays the through image 60 indicated by image data and each focusing area. By this, the various AF areas 61 to 63 is made visible to the user, and focusing operation for tracking a subject can be easily performed. In the digital camera 100 of the present embodiment, the controller 135 may control such display on a display monitor of the digital camera 100, or additionally or alternatively, may control an external display via a connecter included in the digital camera 100 such as an HDMI terminal, for example.

### Second Embodiment

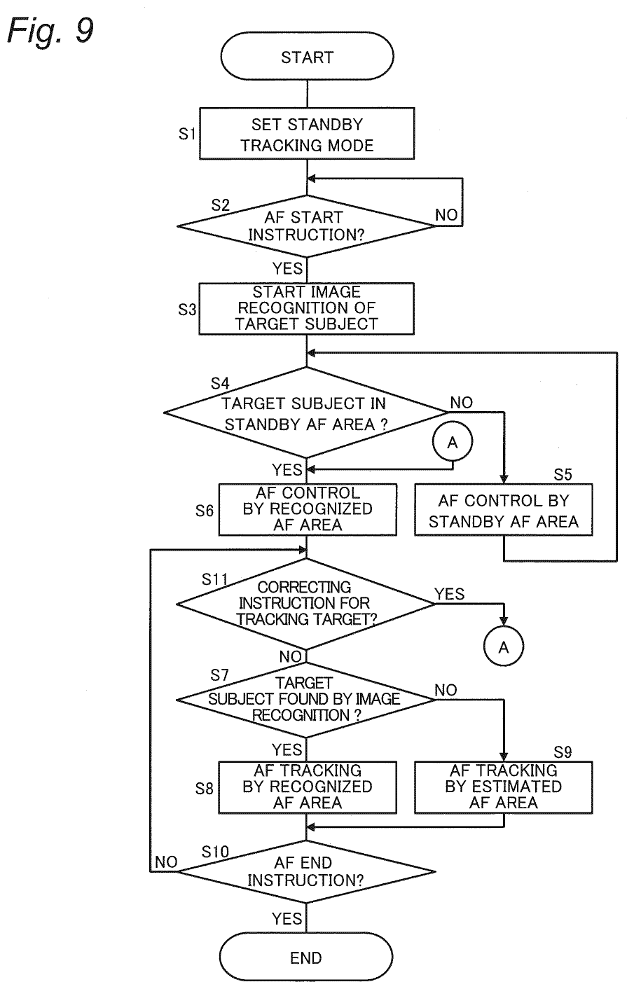

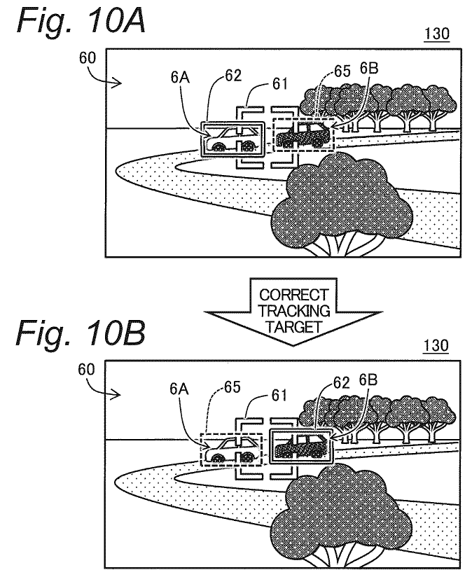

Hereinafter, a second embodiment of the present disclosure will be described with reference to FIGS. 9 to 10. In the first embodiment, an example of operation of the digital camera 100 in the standby tracking mode is described. In the second embodiment, an operation example of the digital camera 100 that selectively tracks a subject desired by the user in an exemplary case where a plurality of subjects or the like are present will be described.

Hereinafter, the digital camera 100 according to the present embodiment will be described, but a configuration and operation similar to those of the digital camera 100 according to the first embodiment will be omitted from description appropriately.

FIG. 9 is a flowchart illustrating operation in the standby tracking mode in the digital camera 100 according to the second embodiment. FIGS. 10A and 10B are diagrams for explaining an operation example of the standby tracking mode in the digital camera 100 of the present embodiment. In the present variation, the controller 135 of the digital camera 100 receives a user's instruction for correcting a tracking target as illustrated in FIG. 9, for example (S11) in addition to performing the processing of steps S1 to S10 similar to that of the first embodiment.

In FIG. 10A, in the digital camera 100 of the present variation, a plurality of subjects 6A and 6B are shown in the vicinity of the standby AF area 61 on the through image 60. At this time, the controller 135 of the digital camera 100 detects one of the subjects, the subject 6A, as a target subject (YES in S4), and causes the display monitor 130 to display the recognized AF area 62 in a manner of tracking the subject 6A (S6). At this time, it is conceivable that the user may want to shoot the subject 6B different from the subject 6A being tracked by automatic detection of the digital camera 100.

In view of the above, while tracking the subject 6A (S6 to S9), the digital camera 100 according to the present embodiment receives a correction instruction for a tracking target in various input interfaces such as the user interface 150 and the microphone 160, for example (S11). For example, the correction instruction for a tracking target in step S11 may be operation on up, down, left, and right direction keys of the user interface 150, or voice input such as “right” or “up” by the microphone 160.

FIG. 10B illustrates a display example of the through image 60 according to a correction instruction for a target of tracking by the digital camera 100 from the state of FIG. 10A. When the correction instruction for a tracking target is input (YES in S11), the controller 135 of the digital camera 100 changes the tracking target according to the correction instruction, and updates the recognized AF area 62 with the subject area 65 (FIG. 10A) of a recognition result of the subject 6B as a new tracking target (S6). In this manner, after the correction instruction (YES in S11), the digital camera 100 of the present embodiment can perform AF operation so as to track the subject 6B desired by the user as illustrated in FIG. 10B (S6 to S9).

As described above, the digital camera 100 according to the present embodiment may further include an input interface for inputting an instruction of the user. In accordance with a user instruction on the input interface, the controller 135 changes the target subject 6 to be tracked by the recognized AF area 62 (YES in S11, S6). By this, even if the digital camera 100 of the present embodiment erroneously detects the subject 6A that is not the subject 6B desired by the user, it is possible to correct the subject 6A according to a user instruction and facilitate tracking of the subject 6B desired by the user.

### Other Embodiments

The first and second embodiments are described as above as an example of the technique disclosed in the present application. However, the techniques of the present disclosure can be applied not only to the above embodiment but also to an embodiment in which modification, replacement, addition, or removal is appropriately made. Further, it is possible to form a new embodiment by combining the constituent elements described in the first and second embodiment.

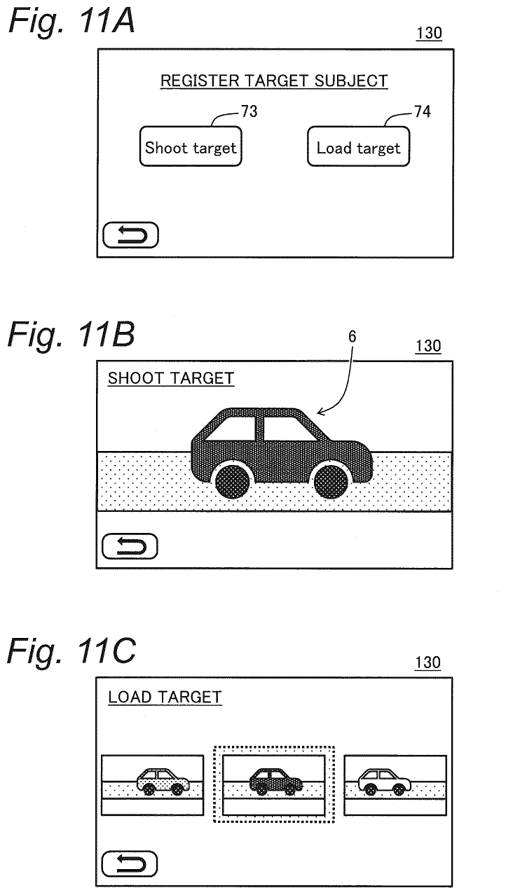

In the first and second embodiments, the operation example of correcting an erroneous detection of a target subject desired by the user by the digital camera 100 is described. The digital camera 100 of the present embodiment may be configured to allow setting of information for facilitating avoidance of such erroneous detection of a target subject. Such a variation will be described with reference to FIG. 11.

FIG. 11 illustrates a variation of a setting screen of a target subject in the digital camera 100. The digital camera 100 of the present embodiment may register an image of a target subject additionally or alternatively of a type of the target subject, as setting information of the standby tracking mode, for example.

FIG. 11A illustrates a display example of a registration screen of a target subject in the present variation. In the present variation, the display monitor 130 of the digital camera 100 displays a registration screen as illustrated in FIG. 11A instead of or subsequent to the setting screen in FIG. 8, for example. The controller 135 receives user operation of selecting an image of the target subject 6 by a target shooting button 73 and a target loading button 74 displayed on the screen in the user interface 150 as a setting interface.

FIG. 11B illustrates a display example of a target shooting screen when a transition is made from the target shooting button 73 in FIG. 11A. The controller 135 prompts the user to shoot an image of the target subject 6 on such a shooting screen, and registers image data of a shooting result in the setting information. Such image registration of the target subject 6 may be performed from image data recorded in advance without particularly limiting to image shooting.

FIG. 11C illustrates a display example of a target loading screen when a transition is made from the target loading button 74 in FIG. 11A. For example, the controller 135 may load image data recorded in the memory card 142, display a list of the image data on the loading screen, receive user operation for selecting an image to be registered, and register the selected image data in the setting information.

As described above, in digital camera 100 of the present embodiment, the setting information for setting the target subject 6 to be detected according to user's operation in a setting interface is not limited to a type of the target subject 6, and may be image data of the target subject 6. In the digital camera 100 of the present embodiment, such setting information is not limited to the above, and may be e.g. color information of the target subject 6, an identification number of the target subject 6, feature information regarding an appearance of the target subject 6, or the like, and such various information may be settable in the digital camera 100 from the setting interface. Such setting information is set in the image recognizer 122 so as to be reflected in image recognition processing in and after step S3, for example.

In the above embodiments, the example in which the setting information of the target subject 6 is set in the image recognizer 122 in advance is described. In the digital camera 100 of the present embodiment, such pre-setting of the target subject 6 does not need to be performed. For example, on the setting screen of FIG. 8, when the type “moving object” is selected, various setting information as described above may be configured not to be set in the image recognizer 122. In such a case, in the detection processing of step S4, the controller 135 of the digital camera 100 may detect a moving subject (i.e., a moving body) based on a change in the through image 60 in the standby AF area 61 or the vicinity of the standby AF area 61. At this time, the image recognizer 122 may perform various recognizable types of image recognition processing to generate output information. After the above, when a moving object is detected, a target subject may be dynamically set based on an image or the like at the time of detection.

In the above embodiments, the example in which the AF areas 61 to 63 are displayed during operation in the standby tracking mode is described, but the method of using such information is not particularly limited to live view display. For example, in the digital camera 100 of the present embodiment, various information during operation in the standby tracking mode may be output as metadata. For example, the controller 135 may output data including information of various the AF areas 61 to 63 used at the time of shooting, information of a focus position, or the like in metadata of a still image or a moving image shot in the standby tracking mode. Such metadata can be used for training data of machine learning related to AF operation of the digital camera 100, for example.

In the above embodiments, various rectangular AF areas 61 to 63 are exemplified (FIGS. 3 and 6, and the like). In the digital camera 100 of the present embodiment, each of the AF areas 61 to 63 may have various shapes without limitation to a rectangular shape. For example, the recognized AF area 62 may have a shape along an outer shape of a subject by image recognition of a segmentation technique. The standby AF area 61 may be set to a shape desired by the user in a pre-setting of a standby mode of the digital camera 100 (see FIG. 7). A focusing area such as the AF areas 61 to 63 may be an area indicating a target of focusing operation in various modes.

In the above embodiments, the example in which the standby tracking mode is provided as one of a plurality of AF modes presented in the selection field 50 on a setting screen of an AF mode is described, but the digital camera 100 of the present embodiment is not limited to this. For example, in the digital camera 100 of the present embodiment, the standby tracking mode may be an operation mode provided in a case where an automatic recognition function is ON in AF modes such as “single-point AF” or “tracking”. When such an automatic recognition function of an AF mode is ON, an option such as “area start” may be additionally presented.

The above embodiments have exemplified the digital camera 100 including the optical system 110 and the lens driver 112. The imaging apparatus of the present embodiment does not have to include the optical system 110 or the lens driver 112, and may be an interchangeable lens camera, for example.

In the above embodiments, a digital camera is described as an example of the imaging apparatus, but the imaging apparatus is not limited to the digital camera. The imaging apparatus of the present disclosure only has to be electronic device having an image shooting function (e.g., a video camera, a smartphone, and a tablet terminal).

### ASPECT EXAMPLES

Hereinafter, various aspects of the present disclosure will be exemplified.

A first aspect according to the present disclosure is an imaging apparatus including: an image sensor that captures a subject image formed via an optical system to generate image data; and a controller that controls focusing operation by the optical system. Before a subject is detected in a first focusing area, the controller causes the optical system to perform the focusing operation, based on the first focusing area, the first focusing area being arranged in advance in a captured image indicated by the image data. After the subject is detected in the first focusing area, the controller causes the optical system to perform the focusing operation with tracking the subject over a range away from the first focusing area.

A second aspect is the imaging apparatus according to the first aspect, wherein the controller controls a display that displays the captured image indicated by the image data. The controller causes: the display to display the first focusing area arranged in advance in the captured image; the optical system to perform focusing operation, based on the first focusing area, before the subject is detected in the first focusing area; and the display to display a second focusing area after the subject is detected in the first focusing area, the second focusing area tracking the subject over the range away from the first focusing area.

A third aspect is the imaging apparatus according to the first or second aspect, further including an image recognizer that recognizes a subject area, based on the image data. The subject area is an area where the subject is located in the captured image. Based on a recognition result of the image recognizer, the controller: does not detect the subject in a case that the subject area is not within a predetermined range from the first focusing area; and detects the subject in a case that the subject area is within the predetermined range from the first focusing area.

A fourth aspect is the imaging apparatus according to the third aspect, wherein the controller displays the second focusing area to track the subject based on a recognized subject area in a case that the image recognizer recognizes the subject area after the subject is detected. The controller displays the second focusing area to track the subject based on a predetermined feature amount in the captured image in a case that the image recognizer does not recognize the subject area after the subject is detected.

A fifth aspect is the imaging apparatus according to any one of the first to fourth aspects, further including a setting interface that sets at least one of arrangement of the first focusing area in the captured image, or a subject as a target of the detection, according to a user operation.

A sixth aspect is the imaging apparatus according to any one of the first to fifth aspects, wherein the controller has a plurality of operation modes for controlling the focusing operation respectively. In a case that a specific operation mode among the plurality of operation modes is set, the controller displays the first focusing area, and displays the second focusing area after the subject is detected in the first focusing area.

A seventh aspect is the imaging apparatus according to any one of the first to sixth aspects, further including an input interface that inputs a user instruction. The controller changes the subject tracked by the second focusing area according to the user instruction on the input interface.

An eighth aspect is the imaging apparatus according to any one of the first to seventh aspects, further including the display that displays the captured image indicated by the image data and each focusing area.

In the above, the embodiments have been described as examples of the techniques in the present disclosure. For that purpose, the accompanying drawings and the detailed description are provided.

Therefore, the components illustrated in the accompanying drawings and described in the detailed description not only include components essential for solving the problem but also can include, to exemplify the techniques, components that are not essential for solving the problem. For this reason, it should not be immediately recognized that those unnecessary components are necessary only because those unnecessary components are described in the accompanying drawings or the detailed description.

Since the embodiments described above are merely examples of the techniques in the present disclosure, various modifications, replacements, additions, omissions, and the like can be made in the scope of the claims or in an equivalent scope thereof.

The present disclosure is applicable to an imaging apparatus that performs the focusing operation such as autofocus.

1. An imaging apparatus comprising:
an image sensor that captures a subject image formed via an optical system to generate image data; and
a controller that controls focusing operation by the optical system, wherein
before a subject is detected in a first focusing area, the controller causes the optical system to perform the focusing operation, based on the first focusing area, the first focusing area being arranged in advance in a captured image indicated by the image data and
after the subject is detected in the first focusing area, the controller causes the optical system to perform the focusing operation with tracking the subject over a range away from the first focusing area.

2. The imaging apparatus according to claim 1,
further comprising an image recognizer that recognizes a subject area, based on the image data, the subject area being an area where the subject is located in the captured image, wherein
based on a recognition result of the image recognizer, the controller:
does not detect the subject in a case that the subject area is not within a predetermined range from the first focusing area; and
detects the subject in a case that the subject area is within the predetermined range from the first focusing area.

3. The imaging apparatus according to claim 1, wherein
the controller causes:
a display to display the first focusing area arranged in advance in the captured image, the display displaying the captured image indicated by the image data;
the optical system to perform focusing operation, based on the first focusing area, before the subject is detected in the first focusing area; and
the display to display a second focusing area after the subject is detected in the first focusing area, the second focusing area tracking the subject over the range away from the first focusing area.

4. The imaging apparatus according to claim 3,
further comprising an image recognizer that recognizes a subject area, based on the image data, the subject area being a area where the subject is located in the captured image, wherein
based on a recognition result of the image recognizer, the controller:
does not detect the subject in a case that the subject area is not within a predetermined range from the first focusing area; and
detects the subject in a case that the subject area is within the predetermined range from the first focusing area, and
after the subject is detected, the controller displays:
the second focusing area to track the subject based on a recognized subject area in a case that the image recognizer recognizes the subject area; and
the second focusing area to track the subject based on a predetermined feature amount in the captured image in a case that the image recognizer does not recognize the subject area.

5. The imaging apparatus according to claim 3, wherein
the controller has a plurality of operation modes for controlling the focusing operation respectively, and
in a case that a specific operation mode among the plurality of operation modes is set, the controller displays the first focusing area, and displays the second focusing area after the subject is detected in the first focusing area.

6. The imaging apparatus according to claim 3,
further comprising an input interface that inputs a user instruction, wherein
the controller changes the subject tracked by the second focusing area according to the user instruction on the input interface.

7. The imaging apparatus according to claim 3,
further comprising the display that displays the captured image indicated by the image data and each focusing area.

8. The imaging apparatus according to claim 1,
further comprising a setting interface that sets at least one of arrangement of the first focusing area in the captured image, or a subject as a target of the detection, according to a user operation.
